(19) United States
(12) Patent Application Publication
(10) Pub. No.: US 2026/0185636 A1
(43) Pub. Date: Jul. 2, 2026

(54) BENT TUBING WITH HEATER

(71) Applicant: ULTRA CLEAN HOLDINGS, INC., Hayward, CA (US)

(72) Inventors: Michael RAMACCIOTTI, Fremont, CA (US); Alan CAMYRE, Vail, AZ (US); James PRADUN, San Jose, CA (US); Michael SANDERS, Roseville, CA (US); Hyunwook IM, Fremont, CA (US)

(21) Appl. No.: 19/419,330

(22) Filed: Dec. 15, 2025

Related U.S. Application Data
(60) Provisional application No. 63/734,439, filed on Dec. 16, 2024.

(51) Int. Cl. F16L 9/02; B23K 1/008; F16L 13/08

(52) U.S. Cl. CPC F16L 9/02; B23K 1/008; F16L 13/08

(57) ABSTRACT

A flow conduit includes a first configuration having a straight length of tubing having a first open end, a second open end, an inner wall surrounding an interior flow conduit and extending from the first open end to the second open end, and an outer circumferential wall surface extending from the first open end to the second open end, and a temperature control element wound over the outer circumferential surface and adhered thereto with an initial adherence material over an adhered length of the temperature control element, and a second configuration where the length of tubing includes at least one bend therein and at least one portion of the tubing extending from the bend, and the temperature control element wound over the outer circumferential surface is adhered to the outer circumferential surface of the tubing by the initial adherence material over the span of the bend and on the at least one portion of the tubing extending therefrom.

### BACKGROUND

### Field

The present disclosure relates to the fabrication and use of temperature controlled fluid conduits, for example heated fluid flow tubings, wherein a heat transfer element is employed for purposes of passing heat into, or from, a fluid in the tubing, and is disposed on the exterior of the tubing.

### Description of Related Art

Fluid conduits are used in fluid flow systems to enable flow of a fluid, such as a liquid or gas, through a flow passage extending along the length of the interior thereof, and maintain a fluid seal between the interior flow passage and the surrounding ambient. Such tubings are used in fluid control circuits and in processing equipment where a desired fluid useful for a process performed in the processing equipment is delivered to the processing equipment through the fluid conduit.

Fluid circuits, for example those used for process fluids in the food industry and the semiconductor manufacturing industry, as well as for the communication of fluids within fluid operated control circuits, are commonly configured of a plurality of tubings having a through flow passage, and having fittings on the opposed open ends thereof. These tubings often must have curves or bends imposed into them to properly place or locate the inlet fitting end and the outlet fitting end of the tubing for connection thereof into a fluid circuit in the equipment in which the tubing is to be used.

Some fluids require the use of metallic conduits or tubings, and these tubings are commonly configured using straight lengths of tubing cut to a desired length, and imposing one or more bends on the straight length of tubing to configure the tubing into its in use configuration. These fluid conduits or tubings are often configured of a relatively thin-walled, bendable, stainless steel pipe or tubing, which is cut to a desired length from a straight (the longitudinal centerline of the straight tubing follows or nearly follows a straight line path) stock piece of such tubing, that is then then cut to a desired length if needed, and bent to create curved portions thereof between the opposed open ends thereof. Fittings for connection to another tubing, to a fluid control or use component, and pass-through location, or other connection, are attached to the opposed open ends thereof in a fluid tight manner. Where it is critical to ensure that the connection of the fitting to the tubing end is leak free with respect to the fluid to be flowed therein, the fitting is attached by welding or brazing a female or male portion of a male fitting-female fitting pair to the open ends thereof. The tubing and fittings making up the fluid conduit are then connected to a corresponding and mating male or female fitting in a fluid circuit.

Many process fluid use applications require the fluid to be delivered from the exit end of the tubing or into a process environment within a specified pressure and temperature range. To provide the fluid flowing through the tubing to be delivered at the desired temperature and pressure, a temperature control element can be contacted to the exterior wall of the tubing and a desired temperature, cooling flux, or heat generation maintained in the temperature control element sufficient to, through heat transfer through the thin wall of the tubing, maintain a desired temperature in the fluid flowing though the tubing. As a result, condensation of a gas flowing through the tubing can be prevented, and the fluid can be delivered through the tubing at the desired temperature. For example, a heating element in the form of a tube or ribbon, and having one or more electric resistance wires embedded therein, can be contacted to the exterior of the tubing to provide heat to be transferred into the fluid. In this temperature control element, electrical power is applied to the resistance wire, which causes the wire to generate heat.

To control the desired uniformity (or non-uniformity) of the temperature of the fluid within the tubing, it is desired that the heat input to the tubing (or heat withdrawal therefrom) be controlled along the length of the tubing. Commonly, the temperature control element is wound over the exterior wall surface of the tubing at a desired pitch. Here, pitch is the spacing between portions of the temperature control element in the length direction of the tubing over a single circumferential winding of the of the temperature control element over the outer circumferential surface of the tubing as measured along a constant circumferential or azimuthal location of the tubing over the length of the tubing.

Where gases are flowed through the tubing, the tubing often must be sufficiently heated so as to maintain the gas at a temperature above the condensation temperature thereof at the gas pressure of the gas in the tubing over the length of the tubing. This is commonly accomplished by supplying a relatively constant heat output of a temperature control element wound over the tubing, while ensuring that the pitch of the temperature control element over the length of the tubing does not exceed a desired maximum pitch distance, to ensure that the temperature of the inside wall of the tubing at locations midway between adjacent windings in the length direction of the tubing is maintained at a desired temperature, for example above the condensation temperature of a gas flowing in the tubing. As the heat transfer element has a cost which is based, in part, on the length thereof used in a specific application, the designer of the system has a desire to maximize the pitch within an acceptable safety tolerance which will achieve the desired temperature in the fluid in the tubing.

The temperature control element is often affixed to the exterior of the tubing by an adherent, for example a thermally conductive adherent. For example, a resistance wire element can be brazed or welded to the exterior wall of the tubing. The adherent both ensures a heat transfer path between the heat transfer element and the outer wall of the tubing, as well as ensures maintenance of the heat transfer element in the proper location on the tubing out wall. For example, the temperature control element may be configured as a resistance wire heater, which is affixed to the exterior wall of the tubing. By affixing the temperature control element to the outer wall of the tubing with an adherent, a conductive heat transfer path is formed through the adherent to the outer wall surface of the tubing, and thus between the heat transfer element and the body of the tubing. In prior practices, this adherence of the heat transfer element to the tubing is performed after the tubing is bent to its desired final use configuration, because the adherence between the temperature control element and the outer wall of the tubing can be disturbed and ruptured during the bending process. As a result, along the length of the tubing where straight lengths of tubing meet a curved or bent section, the temperature control element must be wound around the bend of the bend section following a complex design requirement which takes into account factors such as the difference in tubing wall length on the inside versus the outside of the bend, maximum acceptable pitch between adjacent heater element portions, and other factors. Here, because of the difficulty of properly winding a heat transfer element around a curved section of tubing and adhering it successfully thereto, it is typical for the spacing between adjacent lengths of the temperature control element to be closer together than needed, to ensure if there is slippage during the process of winding and adhering the heat transfer element in the tubing, the spacing between adjacent winding s at or less than the maximum desired spacing for the application. Likewise, a complex three dimensional manipulation of the tubing as the temperature control element is adhered thereto must be performed while welding or brazing is occurring. As a result, the brazing or welding of the heating element to the outer wall surface of the bent tubing has resulted in excessive scrap, where the heating element is not consistently attached to the outer wall of the tubing, the pitch around the bent portion is out of specification, or other issues such as increased cost to ensure the windings are not too far apart around the bend.

### SUMMARY

Herein, a bent tubing having a temperature control element is provided, wherein the temperature control element is affixed to the tubing prior to the tubing being bent, whilst the adherence of the adherence material to the outer wall of the tubing and to the temperature control element is maintained.

### BRIEF DESCRIPTION OF THE DRAWINGS

FIG. 1 is a perspective view of a straight length of tubing;

FIG. 2 is a perspective view of the tubing of FIG. 1, having a length of a temperature control element wound thereover;

FIG. 3 is a side view of the tubing of FIG. 2, having a bend therein;

FIG. 4 is a schematic side view of a portion of a temperature control element useful herein;

FIG. 5 is a schematic perspective view of a system for winding the temperature control element onto the tubing of FIG. 1;

FIG. 6 is a schematic sectional view of the temperature control element and tubing of FIG. 3, showing the deployment of a brazing compound therebetween;

FIG. 7 is a side view of a portion of tubing showing the deployment of the brazing compound on the tubing of FIG. 2;

FIG. 7a is a side view of an alternative layout of the deployment of the brazing compound on the tubing of FIG. 2;

FIG. 8 is a view of a portion of the tubing of FIG. 2, opened or unwrapped, i.e., a 360 degree plan view of the outer surface thereof, showing the position of individual sections of brazing compound thereon;

FIG. 8a is a side view of an alternative layout of the deployment of the brazing compound on the tubing of FIG. 2.

FIG. 8b is a side view of an alternative layout of the deployment of the brazing compound on the tubing of FIG. 2.

FIG. 9 is a schematic sectional view of the temperature control element and tubing of FIG. 3, showing an alternative deployment of a brazing compound therebetween;

FIG. 10 is a schematic sectional view of the temperature control element and tubing of FIG. 3, showing an alternative configuration of a ribbon of brazing compound therebetween;

FIG. 11 is a schematic sectional view of the temperature control element and tubing of FIG. 3, showing another alternative configuration of a ribbon of brazing compound therebetween

FIG. 12 is a schematic sectional view of the temperature control element and tubing of FIG. 10, showing the distribution of the brazing compound after the temperature control element and tubing have been brazed together;

FIG. 13 is a schematic sectional view of the temperature control element and tubing of FIG. 3, showing an alternative deployment of a brazing compound therebetween;

FIG. 14 is an enlarged view of the brazing compound of FIG. 13;

FIG. 15 is an enlarged view of an alternative configuration of the brazing compound of FIG. 14;

FIG. 16 is a schematic sectional view of the connection of the temperature control element and tubing using the brazing compound configurations of FIGS. 13 to 15; and

FIG. 17 is a schematic view of a vacuum brazing furnace.

### DETAILED DESCRIPTION

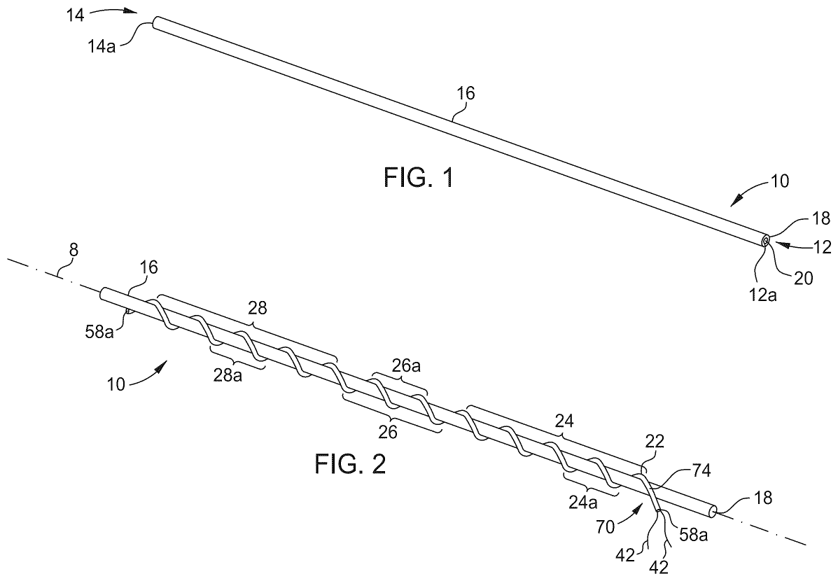

Referring initially to FIG. 1, a length of tubing 10, in a straight or as yet unbent state, in other words, having a central longitudinal axis 8 (FIG. 2) substantially lying along a straight line, is show. The tubing 10 here is, for example, a thin walled length of stainless steel configured as a tube, having a first annular tubing end 12 surrounding a first tubing opening 12a, a second annular tubing end 14 on the opposite end of the length of tubing 10 from the first annular tubing end 12 and surrounding an opening 14a, the first annular tubing end 12 and the second annular tubing end 14 connected to one another over an inner circumferential wall 18 of the tubing 10 and an circumferential outer surface 16 of the tubing 10. The inner circumferential wall 18 extends between the first annular tubing end 12 a and the second annular tubing end 14, and it surrounds the interior flow passage of the tubing 10 which is bounded at its opposed ends by first tubing opening 12a and second tubing opening 14a.

Referring to FIG. 2, tubing 10 of FIG. 1, and having its central longitudinal axis 8 still substantially lying along the straight line is shown with a temperature control element 22 adhered to the circumferential outer surface 16 of the tubing 10. Here, the temperature control element 22 extends circumferentially around the tubing 10 by a number of turns, and longitudinally along the circumferential outer surface 16 of the tubing 10 from a position on the tubing 10 adjacent to the first annular tubing end 12 to a location adjacent to the second annular tubing end 14. Here, the spacing of a single turn 30 of the temperature control element 22 in the length direction of the tubing 10 between the first annular tubing end 12 and the second annular tubing end 14 is considered the pitch of the winding of the temperature control element 22 on the circumferential outer surface 16 of the tubing 10, and is typically measured or considered as windings per unit of length, for example windings per inch or windings per cm. Here, a winding is one full 360 degree turn or wrap of the temperature control element 22 over the circumferential outer surface 16 of the tubing 10. On the tubing 10 shown in FIG. 2, the temperature control element 22 is adhered to the circumferential outer surface 16 of the tubing 10 using three pitches, at a first pitch 24a in a first pitch section 24. At a second pitch 26a in a second pitch section 26 of the temperature control element 22 on the circumferential outer surface 16 of the tubing 10. And, at a third pitch 28a in a third pitch section 28 of the temperature control element 22 on the circumferential outer surface 16 of the tubing 10. Here, the ‘a of the winding of the temperature control element in the second pitch section 26 is different than that of the first pitch 24a of the temperature control element in the first pitch section 24 and the third pitch 28a in the third pitch section 28. Additionally, the third pitch 28a in the third pitch section 28 and the first pitch 24a in the first pitch section 24 can be the same value (same pitch), or different values (different pitches).

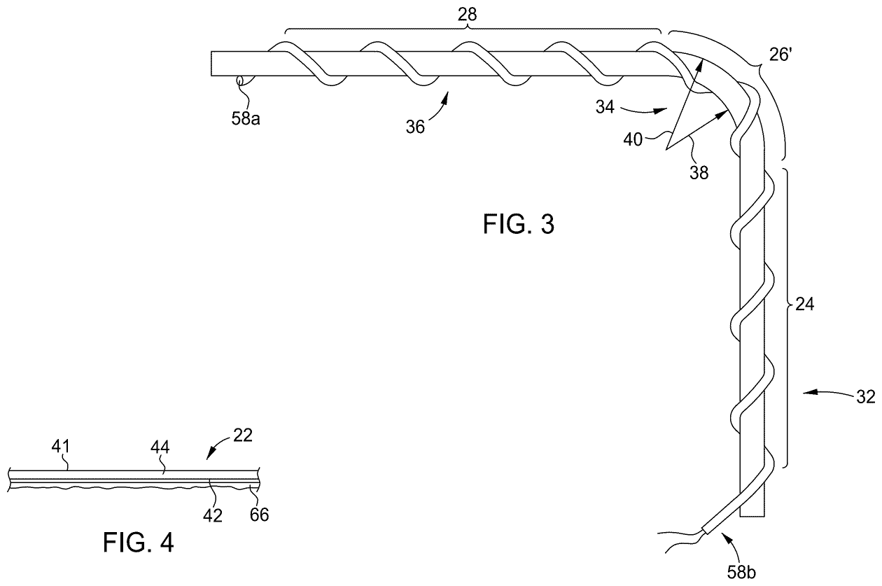

Tubing 10 is supplied from the manufacturer thereof to be bent from the straight or unbent configuration thereof in FIG. 2 to a bent configuration, such as that shown in FIG. 3. When the tubing is bent about or along a curve having a desired radius, the portion of the thin wall of the tubing on the inner radial portion of the tubing 10 along the bend will compress in the length direction of the tubing 10, and the portion of the thin wall of the tubing on the outer radial portion of the tubing 10 along the bend will extend or stretch in the length direction of the tubing 10.

As shown in FIG. 3, the straight or unbent tubing 10 of FIG. 1, having the temperature control element 22 already adhered thereto as shown in FIG. 2, has been bent along a radius to yield a first straight or unbent first sub-portion 32 having the first pitch section 24 of the temperature control element 22 still adhered thereto, a second straight or unbent second sub portion 36 having the third pitch section 28 of the temperature control element 22 still adhered thereto, and a bent sub-portion 34, having the second pitch section 26 of the temperature control element 22 still adhered thereto. Here the pitch of the first sub-portion 32 remains substantially unchanged from that of the first pitch section 24 of FIG. 2, and the pitch of the bent sub-portion remain substantially unchanged from the pitch of the third pitch section of FIG. 2. However, the pitch of the temperature control element 22 in the bent sub-portion 34, which remains adhered to the tubing 10 during the bending thereof, and which corresponds to the second pitch section 26 of the straight or unbent tubing of FIG. 2, is a different pitch than it was in the unbent condition of the tubing 10 of FIG. 2.

As the tubing 10 is bent from the unbent configuration thereof in FIG. 2 to the bent configuration thereof of FIG. 3, the length of the second pitch section 26 extending along the circumferential outer surface 16 of the tubing 10 at the smaller radius 38 of the bend, and thus the distance between the windings of the temperature control element 22 at that location, is shortened as compared to its length in FIG. 2, and the length of the second pitch section 26 extending along the outer surface 16 of the tubing 10 at the larger radius 40 of the bend and thus the distance between the windings of the temperature control element 22 at that location is extended, i.e., is longer, as compared to its length in FIG. 2. This results in the pitch of the temperature control element 22 at the smaller radius 38 of the bend becoming greater than the second pitch 26a, i.e., having more windings or fractions of windings per unit length and the pitch of the temperature control element 22 at the larger radius 40 of the bend becomes smaller (the number of windings per unit length is less) than the second pitch 26a. Thus, a modified second pitch 26′ is formed. Because the temperature control element 22 remained adhered to the tubing 10 as it was bent from the unbent straight configuration thereof in FIG. 2 to the bent configuration thereof of FIG. 2, the spacing between adjacent windings of the temperature control element 22 at the inner radial surface is less than that same spacing in the second pitch section 26 of FIG. 2, and the spacing between adjacent windings of the temperature control element 22 at the outer radial surface is greater than that same spacing in the second pitch section 26 of FIG. 2. Here, by properly spacing the windings in the second pitch section 26 and adhering them to the circumferential outer surface 16 of the tubing 10 prior to the bending of the tubing 10, the maximum distance between the windings of the temperature control element 22, which occurs at the larger radius 40 surface of the circumferential outer surface 16, can be made no greater than the unmodified first and third pitches of the first pitch section 24 and the third pitch section 28. Alternatively, the tubing user or tubing designer can relatively precisely position the body of the temperature control element 22 wound about the tubing 10 at a desired spacing along the outer radial surface of the bend in the outer surface 16 of the tubing 10 and likewise along the inner radial surface of the bend in the outer surface 16 of the tubing 10, as a design choice. This includes forming regular spacings of the windings in the second pitch section 26 (a single pitch), or varying pitches of the windings in the second pitch section 26 (a variable pitch or two or more pitches in the second pitch section 26).

Here, to affix the temperature control element 22 to the tubing 10, a brazing process is used with the tubing in its straight, unbent, condition. For example, the brazing process may be a vacuum brazing process. Here, as shown in FIG. 4, the temperature control element 22 is in the form of a relatively straight rod or tube having an outer metal jacket 41, and it includes a resistance heating element 42 in the form of a wire extending along the length of the interior of the generally straight outer metal jacket 41. An electrical insulating material, such as a ceramic insulation 44, is provided between the resistance heating element 42 and the interior surface of the outer metal jacket 41. By electrically powering the resistance heating element 40 using a power supply (not shown), the resistance of the resistance heating element 42 evolves heat therein, which passes through the insulation 44 and raises the temperature of the outer surface of the outer metal jacket 41 proportionally with the amount of power dissipated by the resistance of the resistance wire of the resistance heating element 42. For example, the resistance heating element may be composed of a single element or wire or strand having an electrical interconnection point at opposed ends of the temperature control element, or a single element, wire or strand extending in a first portion from an opening at one end of the outer metal jacket 41, and forming a U at the opposite end of the interior of the jacket from with a second portion of the wire extends to a location outwardly of the open end of the tubular jacket.

To position and affix the temperature control element 22 on the tubing 10, an assembly fixture 50 is used to secure at least a portion of the temperature control element 22 to the outer surface 16 of the tubing, while the tubing is in the unbent condition, i.e., in the straight line configuration. Here, portions of the temperature control element 22 adjacent to its opposed ends may extend at a tangent to the outer surface of the tubing 10 as shown in FIG. 2, or, one or both ends of the temperature control element 22 may be affixed to the outer surface of the tubing 10, i.e., the opposed ends of the temperature control elements are physically adhered to the circumferential outer surface 16 of the tubing 10. Additionally, a fixing agent, for example a weld or a brazing compound, can be deployed to continuously simultaneously contact the outer surface of the temperature control element 22 with the circumferential outer surface 16 of the tubing 10, from the initial affixed location of the temperature control element 22 to the tubing 10 to the final affixed location of the temperature control element 22 to the circumferential outer surface 16 of the tubing over the length of the temperature control element 22 from the initial to final location of affixation to the circumferential outer surface 16 or the tubing 10.

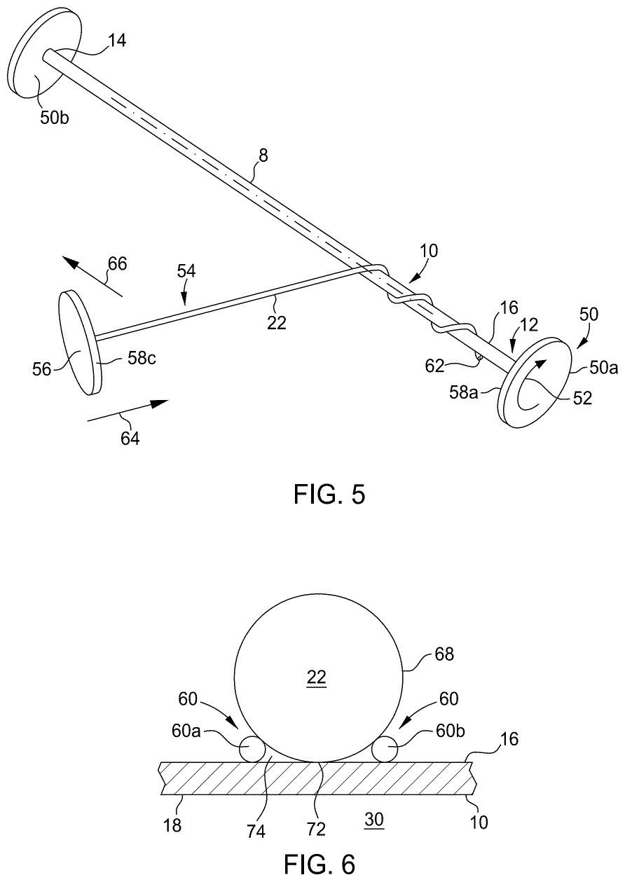

In FIG. 5, an exemplary assembly fixture to wind the temperature control element 22 over the circumferential outer surface 16 of the tubing is shown, and it includes a first rotating clamp 50a connected to the first annular tubing end 12 of the tubing 10, and a second rotating clamp 50b connected to the second annular tubing end 14 of the tubing 10. The first and second rotating clamps 50a, 50b are configured to rotate in the rotational direction 52, to rotate the tubing 10 along the tubing's longitudinal central axis 8. This motion can be provided by an operator physically rotating the first and second rotating clamps 50a, 50b in the same direction, or by a motor operatively connected directly to one or both of the first and second rotating clamps 50a, 50b, wherein the rotation of one of the first and second rotating clamps 50a, 50b imparts the same rotation to the other of the first and second rotating clamps 50a, 50b. The first and second rotating clamps 50a, 50b can, for example, be held in bearings such as roller bearings and a shaft extend from one of the first and second rotating clamps 50a, 50b for connection to a pulley or other drive coupling coupled to a motor. To reduce torque induced strain and thus twist in the tubing 10, preferably both of first and second rotating clamps 50a, 50b are actively rotatably driven at the same rotational speed and in the same rotational direction simultaneously. Alternatively, the temperature control element can be wound around a stationary tubing 10, or the tubing 10 can be rotated while the temperature control element is likewise mover over the outer circumferential outer surface of the tubing 10, so that both the tubing 10 and the temperature control element 22 are moving simultaneously.

Assembly fixture 50 also includes a temperature control element feeding mechanism 54, which is configured to provide tension on the temperature control element, such as a resistance wire heater as a temperature control element 22, as it is wound onto the outer surface of the rotating tubing 10. Temperature control element feeding mechanism 54 includes a temperature control element chuck 56, to which the second end 58b of the temperature control element is securable, where the first end of the temperature control element 22 is tacked or clamped to the circumferential outer surface 16 of the tubing 10. The temperature control element chuck 56 is configured to move in a straight line path toward the location of the tubing 10 during the winding of the temperature control element onto the outer surface of the tubing 10. This can be performed manually, or on a slide arrangement connected to a base on which the rotating clamps 50a, 50b are rotatably mounted.

To position the temperature control element 22 in a circumferentially wound position over the outer surface 16 of the tubing 10 at desired pitches, a first end 58 of the temperature control element is secured to a desired location on the exterior surface of the tubing 10. This can be accomplished using, for example a clamp, or by tack welding or brazing the first end 58 portion of the temperature control element to the outer surface of the tubing 10. Then, the first and second rotating clamps 50a, 50b are simultaneously rotated in rotational direction 52, while the temperature control element chuck 56 is simultaneously moved (arrow 64) toward the tubing 10 and in direction 66 which is parallel to the longitudinal axis 8 (FIG. 1) of the tubing 10. The speed or velocity of the movement of the temperature control element chuck 56 in the direction of arrow 64 relative to the rotational speed of the first and second rotating clamps 50a, 50b defines the winding pitch of the temperature control element on the exterior surface of the tubing 10.

For example, to achieve the three pitches (the first through third pitches) 24a, 26a and 28a of the temperature control element 22 on the tubing 10 as shown in FIG. 2 (and the resulting disposition on the temperature control element 22 on the outer surface of the tubing 10 of FIG. 3), the temperature control element chuck 56 moves toward the tubing 10 at a constant speed or velocity based on the speed or rotational velocity of the outer surface 16 of the tubing 10 as it is rotated, but the speed of the movement of the temperature control element chuck 56 in the direction 66 is varied. Initially, the temperature control element chuck 56 moves at a first speed or velocity v1 until the temperature control element is wound over the tubing 10 to form the first pitch section 24. Then, the speed or velocity of the temperature control element chuck 56 in the direction 66 is reduced to v2, lower than v1, until the temperature control element is would over the tubing 10 for the full length of the second pitch section 26. As a result, the winding pitch of the temperature control element chuck 56 will be greater in the second pitch section 26 than in the first pitch section 24. At this juncture, the speed or velocity of the temperature control element chuck 56 in the direction 66 is increased to v3, until the full length of the temperature control element, minus a lead portion of the temperature control element 22 that can extend at a tangent to the circumferential outer surface 16 of the tubing 10, is wound over the tubing 10. Here, the winding pitch of the temperature control element in the third pitch section 28 has a greater spacing than in the second pitch section. Additionally, v1 and v2 can be the same speed and velocity, such that the winding pitch of the temperature control element in the first pitch section 24 and third pitch section 28 are the same. The velocity of speed of the movement of the temperature control element 22 in the direction 64 is preferably no greater than the surface velocity or rotational velocity of the outer surface 16 of the tubing (tangential velocity where the temperature control element 22 is meeting the outer surface 16 of the tubing 10) to maintain tension on the temperature control element 22 as it is wound over the circumferential outer surface 16 of the tubing 10.

After the temperature control element 22 has been wound onto the circumferential outer surface 16 of the tubing 10, a portion of the temperature control element adjacent to the second end 58b of the temperature control element 22 may be positioned to extend tangentially from the circumferential outer surface 16 of the tubing 10 as shown in FIG. 2. At the location where the portion of the temperature control element adjacent to the second end 58b of the temperature control element 22 begins extending tangentially from the circumferential outer surface 16 of the tubing 10, the temperature control element can be temporarily clamped or otherwise secured to the circumferential outer surface 16 of the tubing 10.

Once the temperature control element is wound over the circumferential outer surface 16 of the tubing 10 at the desired pitch(es), the temperature control element 22 must be physically secured to the circumferential outer surface 16 of the tubing 10 in such a manner that the tubing 10 can be bent without causing a disruption in the connection between the outer circumferential surface of the tubing 10 and the outer surface of the temperature control element 22. Here, a brazing compound is used to connect the temperature control element 22 to the outer circumferential outer surface of the tubing 10 such that the brazing compound, after brazing, provides an adherence material and thus securement between these elements and a heat conduction path between the temperature control element 22 and the tubing 10.

To ensure that there are no gaps in the brazed joint connecting the circumferential outer surface 16 of the tubing 10 to the outer surface of the temperature control element, in one aspect hereof brazing compound 60 is applied to the circumferential outer surface 16 of the tubing 10, the outer surface of the temperature control element, or both, as shown in FIG. 6, along the locations where the outer surface of the temperature control element 22 will be brazed to the circumferential outer surface 16 of the tubing 10, in a manner in which spaces are provided to allow gas (air) entrained in the vent space 74 between the circumferential outer surface 16 of the tubing 10 and of the temperature control element 22 bounded by the brazing compound 60 to vent. Preferably, the brazing of the temperature control element 22 to the circumferential outer surface 16 of the tubing 10 using the brazing compound 60 results in the brazing compound 60 distributing into the vent space 74 during the brazing, such that the brazing material of the brazing compound 60 is disposed to either side of the location of the temperature control element 22 closest to the circumferential outer surface 16 of the tubing, here element location 72, as shown in FIG. 6.

To provide this result, as shown in FIGS. 6 to 8, the brazing compound 60 is, in one example, applied to both sides of the element location 72 as brazing compound 60a, 60b in discrete multiple sections or sections 82, 84 of first and second strips 76a, 76b, such that a gap 86 is disposed between adjacent ones of the sections 82 of the first strips 76a, and between the sections 84 of the second strips 76a. Here, each strip 76a corresponds to the brazing compound 60a in FIG. 6, and strip 76b corresponds to the brazing compound 60b in FIG. 6. Here, each section 82, 84 of each strip 76a, 76b has a width 78 and a length 80, wherein the length 80 here is greater than the width 78. Each section 82, 84 extends on the circumferential outer surface 16 of the tubing 10 spaced from, and generally parallel to, the element location 72 of the temperature control element 22 on the outer circumferential surface 16 of the tubing 10. The sections 82 of the strip 76b are located on one side of the element location 72, and the sections 84 of the strip 76a are located on the opposite side of the element location 72 from the strip 76b, and strips 76a, 76b are generally equally spaced from element location 72 along the circumferential outer surface 16 of the tubing 10. In a direction tangent, and normal to, a line at the element location 72 extending along the length of the temperature control element facing the circumferential outer surface 16 of the tubing 10, a portion of each first strip 76a at its opposed ends in the length direction overlaps with a portion of each second strip 76b at its opposed ends in the length direction. In other words, a line extending perpendicular to the element location 72 extending along the length of the temperature control element facing the circumferential outer surface 16 of the tubing 10, and at or immediately inwardly of the end of a first strip 76a in the length 80 direction, will intersect the body of the strip 76b on the opposite side of the line extending perpendicular to the line at the element location 72 extending along the length of the temperature control element facing the circumferential outer surface 16 of the tubing 10. Additionally, the locations of the gaps in the strips 76a, 76b do not overlap in the direction perpendicular to the position of the element location 72 along the length of the circumferential outer surface 16 of the tubing. Where two strips 76a, 76b of the brazing compound are used to adhere the temperature control element 22 to the circumferential outer surface 16 of the tubing 10, the gaps 86 allow any gas trapped between the temperature control element and the brazing compound of the strips 76a, 76b in the vent space 74 to either side thereof to escape from that volume as the temperature control element 22 is adhered to the circumferential outer surface 16 of the tubing.

Here, the brazing compound can be supplied in the form of a ribbon as shown in section in FIG. 10, which is wound over the tubing 10 at the desired pitch of the temperature control element 22 on the circumferential outer surface 16 of the tubing. Similarly to the brazing compound 60 shown in FIG. 6, the ribbon of brazing compound may be applied to the circumferential outer surface 16 of the tubing 10 before the temperature control element 22 is wound thereover, such that a portion of the ribbon of brazing compound 60 extends between a location spaced from the element location 72 along the circumferential outer surface 16 of the tubing over the length of the wound portion of the temperature control element 22 on the tubing 10. Thus, each of the strips 76a, 76b of the ribbon of brazing compound (with or without the gaps 86 therein), will have the same pitch as the element location 72, and thus the same pitch as the immediately adjacent surface of the temperature control element 22.

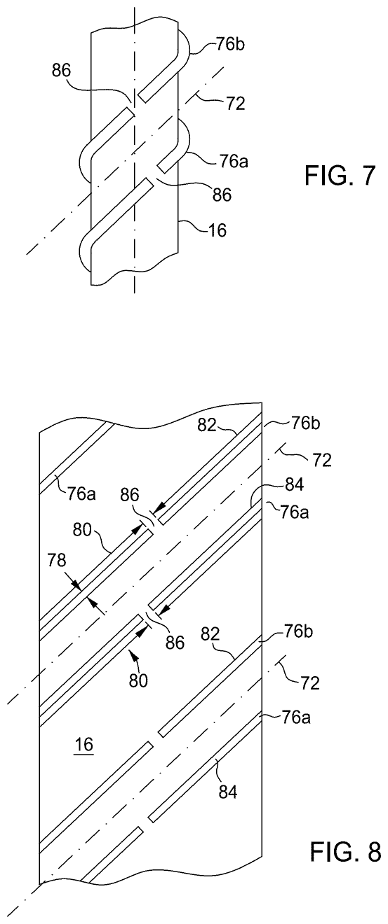

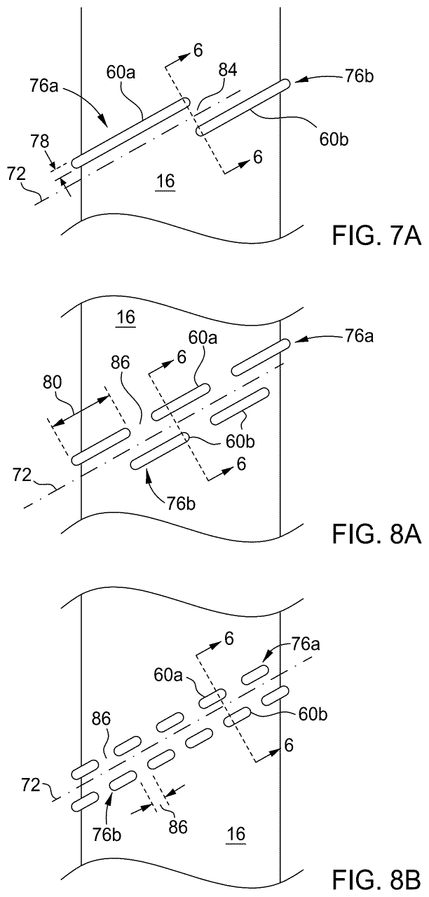

In FIGS. 7a, 8a and 8b, the layout and sizing of the strips 76a, 76b of the brazing compound 60 have different lengths 80 or layout as compared to those of FIG. 7. In FIG. 7a the strips 78a, 78b are provided such that a smaller overlap region between the end of one strip 76a and the end of a second strip 76b located on the other side of the element location 72 is less than that of FIG. 7. In FIGS. 8a and 8b, the lengths 80 of the strips 76a, 76b are smaller than those of FIG. 7.

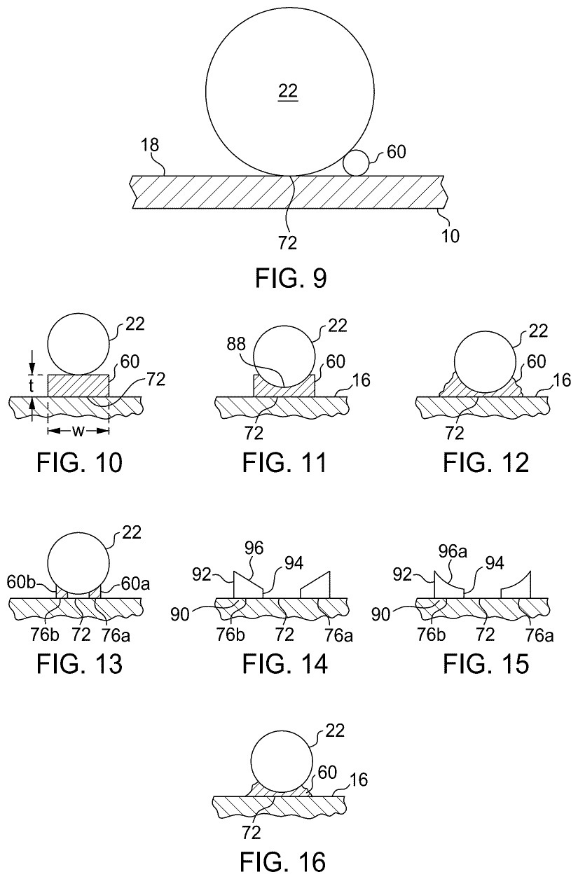

In FIG. 9, the brazing compound 60 is shown abutting only a single side of the temperature control element 22, in contrast to the employment thereof on either side of the temperature control element 22 as shown in FIG. 6. Here, because the brazing compound 60 is on only one side of the temperature control element 22, the risk of trapping gas between the temperature control element 22 and the element location 72 on the circumferential outer surface 16 of the tubing, resulting in a gap between the brazed in place temperature control element 22 and the circumferential outer surface 16, is eliminated. Here, by contacting the brazing compound 60 in its pre-brazed condition in contact with both the circumferential outer surface 16 of the tubing 10 and the outer surface of the temperature control element 22, when the liquidus temperature of the brazing material is reached it can flow into the region directly adjacent to the element location 72 and, if a gap is there present between the circumferential outer surface 16 and the outer surface of the temperature control element, the flowing brazing compound 60 will penetrate and fill that gap so that upon cooling a solid connection of brazing compound 60 is present between the temperature control element 22 and the element location 72.

In FIG. 10, the ribbon of brazing compound 60 is shown in section as having a generally rectangular cross section, with a low aspect ratio (width w greater than thickness t). Additionally, in FIG. 10, a single length of brazing compound 60 is used to connect the temperature control element 22 to the circumferential outer surface 16 of the tubing 10. In other words, the brazing compound extends as a single continuous strip between the connecting portions of the temperature control element 22 and the circumferential outer surface 16 of the tubing 10 with no gaps 86. Here, the brazing compound 60, prior to the brazing operation, is interposed between the temperature control element 22 and the circumferential outer surface 16 of the tubing 10 over the entire length of the element location 72 along the length of the tubing 10. The width w is here large enough, compared to the diameter of the temperature control element 22 and the positioning tolerance of the winding placement of the temperature control element 22 on the circumferential outer surface 16 of the tubing 10, to ensure that as the temperature control element 22 is would onto the tubing 10, it will wind onto the brazing compound 60.

FIG. 11 shows an alternative construct of the brazing compound 60 of FIG. 10, where the temperature control element facing surface of the brazing material is recessed to form a curved brazing material surface 88, where the curve has the same radius as that of the outer surface of the temperature control element 22. The maximum depth location of the curved brazing material surface 88 is preferably located over the element location 72. Thus, this concavely curved brazing material surface 88 helps ensure that the temperature control element 22 is centered in the length of brazing material extend circumferentially around and along the length of the element location 72. After the brazing process is performed, the resulting joining of the temperature control element 22 to the outer circumferential surface 22 will generally appear as shown in FIG. 12, where a thin portion of the brazing material extends between the temperature control element 22 and the circumferential outer surface 16, and brazing material remains to either side of the element location 72.

Referring to FIG. 13, an alternative brazing material cross section so shown, where first and second strips 76a, 76b of FIGS. 6 and 7 have a trapezoidal shape. As shown in FIG. 14, each of these first and second strips 66 a, b, in section, include a base 90, a first sidewall 92 extending a first distance from the base 90, a second sidewall 94 extending a second distance from the base 90, the second distance less than the first distance, and a sloped wall 96 extending between the ends of the first and second sidewalls 92, 94 distal to the base 90. The second walls 66 of the first and second strips 76a, b face one another, such that a truncated trough is formed for receipt and alignment of the temperature control element 22 thereagainst. In FIG. 15, sloped wall 96 is modified as compared to that of FIGS. 13 and 14, and here the sloped wall follows a curve generally matching that of the outer surface of the temperature control element. Here, two individual strips of brazing compound, set out with the gaps 86 as shown in FIG. 7, and 8, is employed, allowing for a gas escape mechanism during brazing, The resulting post brazed adherence of the temperature control element 22 to the circumferential outer surface 16 of the tubing 10 is shown in FIG. 16.

During the brazing process, when the brazing compound 60 (60a, 60b) is heated to at least its liquidus temperature or its melting temperature, it will flow from the locations of the strips 76a, 76b and into the vent space 74, including any gap between the element location 72 and the circumferential outer surface 16 of the tubing, over the length of the element location along the interface of the tubing 10—temperature control element 22 facing surfaces. When cooled, a continuous length of brazing compound 60 will extend throughout the vent space 74 as shown in FIGS. 12 and 16, over the length of the element location along the tubing 10—temperature control element facing surfaces.

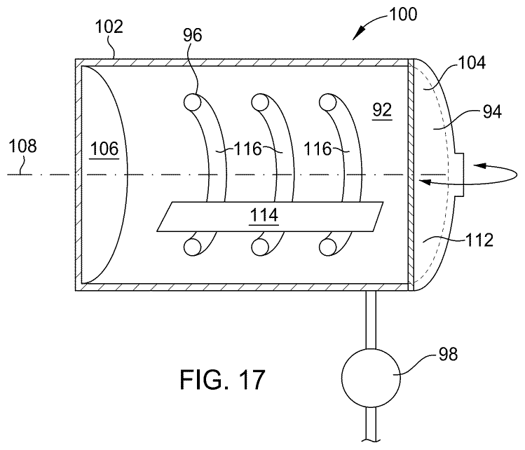

To perform the brazing process, a vacuum brazing system 100 shown schematically in FIG. 17 is employed. Here, the vacuum brazing system 100 includes a sealable chamber including an enclosure 92 and a door 112, a heating source such as coils 116, a vacuum system 98, and optionally a gas source. Sealable enclosure is configured with, for example, a cylindrical wall 102 having on openable end 104 and a generally circular rear wall 106. Here, the centerline 108 of the cylindrical wall extends generally horizontally, i.e., perpendicular to the gravity vector, and the openable end 104 is hingedly connected to the door 112 configured to be sealingly closed over the open end 104 thereof. A support surface 114 is located generally horizontally in the sealable enclosure 92, for the receipt and support of workpieces therein.

The heating system can be any system capable of heating the brazing material to the liquidus temperature thereof. For example, a plurality of electrically conductive coils 116 can be positioned within the enclosure 92 surrounding the support surface 114. Imposing an alternating current electrical signal on, or flowing an alternating current electrical signal through, the coils 116 results in inductive coupling of energy into the metallic components of the enclosure, including metallic workpieces and a metallic brazing material. This heats the metallic components to the liquidus temperature of the brazing material, allowing the brazing material to flow to form a desired profile of the brazing material between the parts being brazed, for example the profile of FIG. 10.

Once parts to be brazed together are loaded onto the support surface 114, and the door 112 sealingly closed over the open end 104, the vacuum system 98 pumps gas from the sealed internal enclosure to reduce the gas pressure inside of the vacuum brazing system 92. As the pressure is reduced, oxygen is pumped out of the sealed enclosure, until a desired low pressure and oxygen depletion level is reached. Then the parts on the support surface, for example the straight length of the tubing 10, the temperature control element 22 would thereover, and the brazing compound 60 are heated using the coils 116 to the liquidus temperature thereof and maintained at that temperature for a period of time to distribute the brazing compound 60 by capillary action to achieve a desired profile thereof between the parts. The brazed together temperature control element 22 and the tubing 10 are then passively or actively cooled, such as by flowing a coolant through cooling channels on the exterior, interior, or both of the vacuum brazing system, until the brazing compound is sufficiently below its solidus temperature that minimal oxidation will occur when it is exposed to air. The sealed enclosure is then vented until the interior volume reaches the same pressure as the surrounding ambient, and the door is opened and the now brazed together components are removed.

Applicants have found that the use of a NiB brazing material as the brazing compound 60, to braze a tubing 10 formed of 316L stainless steel or Hastelloy to a temperature control element having an outer tube or jacket formed of 304 stainless steel or Inconel 600 series results in the formation of a continuous braze layer and a tubing, having the temperature control element brazed thereto, that can be bent to the desired final orientation with the temperature control element 22 brazed thereto, without the temperature control element or the tubing separating from the braze material. For example, a BNi2, ASM 4777 brazing material as the brazing compound 60 has been found to provide these properties.

What is claimed is:

1. A flow conduit comprising:
in a first configuration thereof, a straight length of tubing having a first open end, a second open end, an inner wall surrounding an interior flow conduit and extending from the first open end to the second open end, and an outer circumferential surface extending from the first open end to the second open end, and a temperature control element wound over the outer circumferential surface and adhered thereto with an initial adherence material over an adhered length of the temperature control element; and
in a second configuration the length of tubing includes at least one bend therein and at least one portion of the tubing extending from the bend, and the temperature control element wound over the outer circumferential surface is adhered to the outer circumferential surface of the tubing by the initial adherence material over the span of the bend and on the at least one portion of the tubing extending therefrom.

2. The flow conduit of claim 1, wherein the adherence material comprises a brazing compound.

3. The flow conduit of claim 2, wherein the brazing compound comprises bismuth.

4. The flow conduit of claim 1, wherein in the first configuration thereof, the temperature control element is wound at a first pitch in a first region of the outer surface of the tubing, and at a second pitch, different than the first pitch, in a second region thereof; and
the bend in the second configuration of the tubing is in the second region.

5. The flow conduit of claim 1, wherein the tubing comprises stainless steel.

6. A method of manufacturing a bent tubing comprising a metal having a temperature control element adhered thereto, comprising:
providing a straight length of tubing having an outer circumferential wall surface and opposed ends;
winding a temperature control element over the outer circumferential wall surface in at least a first region thereof and a second region thereof;
adhering the temperature control element to the straight length of tubing; and
bending the tubing with the temperature control element adhered thereto in the second region.

7. The method of claim 6, further comprising providing a brazing compound between the temperature control element and the adjacent surface of the outer circumferential wall of the straight length of tubing.

8. The method of claim 7, further comprising winding the temperature control element over the outer circumferential wall surface in at least a first region thereof and a second region thereof and in contact with the brazing compound in the over the outer circumferential wall surface in at least a first region thereof and a second region of the tubing.

9. The method of claim 8, further comprising:
heating the brazing compound to at least its liquidus temperature while it is contacting both the temperature control element and the outer circumferential wall of the tubing;
allowing the brazing compound to cool to a temperature below its solidus temperature; and
then bending the tubing in the second region.

10. The method of claim 6, further comprising heating the brazing compound to its liquidus temperature in a vacuum furnace.
